(19) United States
(12) Patent Application Publication
(10) Pub. No.: US 2024/0262120 A1
(43) Pub. Date: Aug. 8, 2024

(54) FRIT FOR DIGITAL PRINTING

(71) Applicant: PEMCO ITALY S.R.L., Milan (IT)

(72) Inventors: Fabio GIOFFREDA, Cambiago (IT); Stefano ZAMPELLA, Cambiago (IT)

(73) Assignee: PEMCO ITALY S.R.L., Milan (IT)

(21) Appl. No.: 18/570,195

(22) PCT Filed: Jun. 21, 2022
(86) PCT No.: PCT/EP2022/066868

§ 371 Date: Dec. 14, 2023

(30) Foreign Application Priority Data
Jun. 21, 2021 (GB) 2108862.0

(51) Int. Cl. B41M 5/00; C03C 3/064; C03C 3/091; C09D 11/03

(52) U.S. Cl. CPC B41M 5/007; C03C 3/064; C03C 3/091; C09D 11/03; C03C 2218/119

(57) ABSTRACT

A frit for digital printing onto a ceramic substrate, wherein the frit comprises: less than 5 wt. % B₂O₃; 0.3-5 wt. % Al₂O₃; 40-60 wt. % Bi₂O₃; 0.2-4 wt. % K2O; 0.1-6 wt. % Li₂O; 0.1-6 wt. % Na₂O; at least 30 wt. % SiO₂; and more than 3 wt. % TiO₂, wherein 5 the frit is in particle form and the particles have a Dv97 particle size distribution value of up to 1.5 microns.

### TECHNOLOGICAL FIELD

Embodiments of the present disclosure relate to a frit. Some relate to a frit for use in digital printing onto a ceramic material such as glass.

### BACKGROUND

Frits can be used to coat ceramic materials such as glass. For example, a frit containing mixture can be applied to automotive glass to provide a contact point for adhesives, protect the adhesives from sunlight, and/or for aesthetic purposes. Such frits should be resistant to chemical or physical degradation. It is also desirable to reduce the amount of toxic substances within the frit.

Printing is the process of producing an image onto a substrate, such as glass. Frits are traditionally applied to automotive glass using screen printing, wherein the frit forms part of a mixture to be applied to the glass. The mixture also includes a pigment. Modern digital printing techniques could also be used to apply the frit to the automotive glass. Digital printing, such as inkjet printing, enables a digital image to be applied directly onto the substrate. Digital printing provides a number of advantages, such as enabling a thinner layer of the frit containing mixture to be applied to the glass. There is thus a requirement to provide a frit that is suitable and effective for use in digital printing onto glass.

### BRIEF SUMMARY

All proportions referred to in this specification are indicated as % by weight of the total composition, unless specified otherwise.

The term “more than” used in this specification is defined as greater than, but not equal to (i.e., >). The term “less than” used in this specification is defined as a smaller value than, but not equal to (i.e., <). The term “at least” used in this specification is defined as greater than or equal to (i.e., ≥). The term “up to” used in this specification is defined as a smaller value than or equal to (i.e., ≤).

According to various, but not necessarily all, embodiments there is provided a frit for digital printing onto a ceramic substrate, wherein the frit comprises: less than 5 wt. % B₂O₃; 0.3-5 wt. % Al₂O₃; 40-60 wt. % Bi₂O₃; 0.2-4 wt. % K₂O; 0.1-6 wt. % Li₂O; 0.1-6 wt. % Na₂O; at least 30 wt. % SiO₂; and more than 3 wt. % TiO₂, wherein the frit is in particle form and the particles have a Dv97 particle size distribution value of up to 1.5 microns.

Possibly, the frit is substantially zinc-free.

Possibly, the frit is substantially barium-free.

Possibly, the frit comprises less than 3 wt. % B₂O₃. Possibly, the frit comprises up to 2.5 wt. % B₂O₃. Possibly, the frit comprises up to 2 wt. % B₂O₃.

Possibly, the frit comprises at least 3.5 wt. % TiO₂. Possibly, the frit comprises at least 4 wt. % TiO₂.

Possibly, the frit comprises at least 2 wt. % Li₂O. Possibly, the frit comprises at least 3 wt. % Li₂O.

Possibly, the frit comprises at least 0.5 wt. % K₂O. Possibly, the frit comprises up to 2 wt. % K₂O.

Possibly, the frit comprises up to 2 wt. % Al₂O₃. Possibly, the frit comprises up to 1 wt. % Al₂O₃.

Possibly, the frit comprises at least 35 wt. % SiO₂.

Possibly, the Dv97 particle size distribution value of the particles is up to 1 micron.

Possibly, the frit comprises: 1-2.5 wt. % B₂O₃; 0.3-1 wt. % Al₂O₃; 42-52 wt. % Bi₂O₃; 0.3-2 wt. % K₂O; 0.5-5 wt. % Li₂O; 0.5-4 wt. % Na₂O; 35-45 wt. % SiO₂; and 3.5-7 wt. % TiO₂.

Possibly, the frit comprises: 1.3-1.9 wt. % B₂O₃; 0.3-0.7 wt. % Al₂O₃; 45-50 wt. % Bi₂O₃; 0.6-1.2 wt. % K₂O; 2.6-3.8 wt. % Li₂O; 1.5-2.5 wt. % Na₂O; 36-42 wt. % SiO₂; and 4-6 wt. % TiO₂.

According to various, but not necessarily all, embodiments there is provided a frit for digital printing onto a ceramic substrate, wherein the frit consists of: less than 5 wt. % B₂O₃; 0.3-5 wt. % Al₂O₃; 40-60 wt. % Bi₂O₃; 0.2-4 wt. % K₂O; 0.1-6 wt. % Li₂O; 0.1-6 wt. % Na₂O; at least 30 wt. % SiO₂; and more than 3 wt. % TiO₂, wherein the frit is in particle form and the particles have a Dv97 particle size distribution value of up to 1.5 microns.

According to various, but not necessarily all, embodiments there is provided a frit for digital printing onto a ceramic substrate, wherein the frit comprises: less than 5 wt. % B₂O₃; 0.3-5 wt. % Al₂O₃; 40-60 wt. % Bi₂O₃; 0.2-4 wt. % K₂O; 0.1-6 wt. % Li₂O; 0.1-6 wt. % Na₂O; at least 30 wt. % SiO₂; and more than 3 wt. % TiO₂.

According to various, but not necessarily all, embodiments there is provided an ink mixture comprising: the frit of any of the preceding paragraphs, a liquid medium, and a pigment.

The liquid medium may be an organic liquid medium. The pigment may be an inorganic pigment.

According to various, but not necessarily all, embodiments there is provided a method of applying the ink mixture of the preceding paragraph to glass, wherein the method comprises digitally printing the ink mixture onto the glass.

According to various, but not necessarily all, embodiments there is provided examples as claimed in the appended claims.

### BRIEF DESCRIPTION

For a better understanding of various examples that are useful for understanding the detailed description, reference will now be made by way of example only.

### DETAILED DESCRIPTION

Examples of the disclosure provide a frit for digital printing onto a ceramic substrate, wherein the frit comprises:
less than 5 wt. % B₂O₃;
0.3-5 wt. % Al₂O₃;
40-60 wt. % Bi₂O₃;
0.2-4 wt. % K₂O;
0.1-6 wt. % Li₂O;
0.1-6 wt. % Na₂O;
at least 30 wt. % SiO₂; and
more than 3 wt. % TiO₂,
   wherein the frit is in particle form and the particles have a Dv97 particle size distribution value of up to 1.5 microns.

It is to be appreciated that a frit is at least partially amorphous, and therefore a reference to an “oxide” does not necessarily imply that the oxide is present in stoichiometric crystalline form in the frit. For example, a reference to aluminium oxide or Al₂O₃ being present in the frit does imply that aluminium and oxide ions are present in the frit, which could for instance be in an amorphous mixed metal oxide. The amorphous mixed metal oxide may for instance also include halide ions. Thus a reference to, for example, aluminium oxide or Al₂O₃ being present in the frit does not necessarily imply that crystalline Al₂O₃ is present in the frit.

Table 1 below illustrates example frits 5 to 7, along with comparative example frits 1 to 4.

The capillary temperature (Tc) of Table 1 is representative of the temperature at which the frit can be applied to a glass substrate. The capillary temperature is determined by preparing the frit as an enamel. The enamel comprises the milled frit and pigment (pigment:frit ratio=25-40:100 by weight), which are solids, loaded into an organic liquid medium at (solids:organic medium ratio=75:25 by weight). The enamel is printed onto glass and fired at 10° C. interval temperatures for 10 minutes. Water is applied to the enamel to test for permeability. The capillary temperature (Tc) is the lowest temperature at which no change in appearance from water applied to the enamel can be observed through the glass.

The acid durability (dE) is determined by testing the enamel described in the paragraph above, when the enamel is printed onto glass. Acid durability can be determined using ASTM C 724-91. In this test, a specific acid (3.7% HCl) is applied for a specific time (15 minutes) at a fixed temperature (20° C.+/−2). The colour of the enamel after the test is compared with the colour of the enamel before the test, and the colour difference is expressed in dE using the L*a*b colourspace (dE=sgrt·(dL²+da²+db²)). The colour difference is determined using a colorimeter. The lower the dE value, the greater the acid resistance. A dE value of ≤1 is typically considered as not discernible to the human eye.

TABLE 1

| | Comparative example frits | | | | Example frits | | |
|---|---|---|---|---|---|---|---|
| | Frit 1 | Frit 2 | Frit 3 | Frit 4 | Frit 5 | Frit 6 | Frit 7 |
| Component | Wt. % | | | | | | |
| Al₂O₃ | 0.99 | 0.99 | 0.99 | 0 | 0.50 | 0.50 | 0.50 |
| B₂O₃ | 2.34 | 2.34 | 2.34 | 4.78 | 3.12 | 1.62 | 4.62 |
| Bi₂O₃ | 55.05 | 52.55 | 50.05 | 48.43 | 48.70 | 47.70 | 50.63 |
| K₂O | 0 | 0 | 0 | 4.9 | 0.91 | 0.91 | 0.77 |
| Li₂O | 0.89 | 0.89 | 0.89 | 1.55 | 3.23 | 3.23 | 2.75 |
| Na₂O | 3.64 | 3.64 | 3.64 | 0 | 2.07 | 2.07 | 1.76 |
| SiO₂ | 33.56 | 36.89 | 39.39 | 32.22 | 36.70 | 39.20 | 34.20 |
| TiO₂ | 2.70 | 2.70 | 2.70 | 3.4 | 4.77 | 4.77 | 4.77 |
| SrO | 0.83 | 0 | 0 | 0 | 0 | 0 | 0 |
| V₂O₅ | 0 | 0 | 0 | 4.73 | 0 | 0 | 0 |
| Frit Property | ° C. | | | | | | |
| Tc (° C.) | 680 | 690 | 690 | 660 | 630 | 630 | 635 |
| | dE | | | | | | |
| Acid Durability: dE | 12.0 | 11.0 | 12.0 | 17.1 | 1.0 | 0.9 | 4.9 |

The example frits of Table 1 are for for digital printing onto a ceramic substrate, such as glass. Example frits 5 to 7 are examples of the frit according to the disclosure. It has been surprisingly found that the frit according to the disclosure provides significantly improved performance relative to prior frits. As illustrated in Table 1, the frit according to the disclosure is significantly more resistant to acid than prior frits, and also has a significantly lower application temperature than prior frits. Therefore, when digitally printed onto glass, the frit can fuse more effectively to the glass substrate, and also exhibit greater durability when exposed to acid rain. Furthermore, the lower application temperature of the example frits enables a higher pigment loading in the frit mixture being applied to the glass substrate.

Furthermore, the frit according to the disclosure includes fewer potentially toxic components, thereby improving safety. For instance, the frit is substantially zinc-free. Frits containing zinc can present a hazard, and frits containing amounts of zinc oxide above a certain threshold, such as 0.25 wt. %, can require hazard classification. In some examples, the frit may contain less than 0.25 wt. % ZnO, or preferably less than 0.1 wt. % ZnO. In some examples, the frits are zinc-free, i.e. comprise no zinc.

Frits containing amounts of barium oxide above a certain threshold, such as 10 wt. %, can require hazard classification. In some examples, the frit may contain less than 10 wt. % BaO. Preferably, the frit contains less than 1 wt. % BaO. Most preferably, the frit contains less than 0.1 wt. % BaO. In some examples, the frit is substantially barium-free. In some examples, the frits are barium-free, i.e. comprise no barium.

In some examples, the frit is substantially lead-free and substantially cadmium-free. In some examples, the frit may contain less than 0.05 wt. % PbO and less than 0.025 wt. % CdO. In some examples, the frits are lead-free and cadmium-free, i.e. comprise no lead or cadmium.

In some examples, the frit is substantially strontium-free. In some examples, the frit may contain less than 0.1 wt. % SrO. In some examples, the frits are strontium-free, i.e. comprise no strontium.

The frit according to the disclosure comprises less than 5 wt. % B₂O₃. Frits with lower levels of boron oxide are desired in view of safety considerations. Frits containing amounts of boron oxide above a certain threshold, such as 3 wt. %, can require hazard classification. In some examples, the frit may contain less than 3 wt. % B₂O₃, less than 2.5 wt. % B₂O₃, or less than 2 wt. % B₂O₃. In some examples, the frit may contain at least 0.1 wt. % B₂O₃, at least 0.5 wt. % B₂O₃, or at least 1 wt. % B₂O₃. Preferably, the frit contains 1-2.5 wt. % B₂O₃. Most preferably, the frit contains 1.3-1.9 wt. % B₂O₃.

The frit according to the disclosure comprises 0.3-5 wt. % Al₂O₃. Frits containing amounts of aluminium oxide below a certain threshold, such as 0.5 wt. %, can require hazard classification. In some examples, the frit contains at least 0.4 wt. % Al₂O₃, or at least 0.5 wt. % Al₂O₃. In some examples, the frit contains up to 3 wt. % Al₂O₃, up to 2 wt. % Al₂O₃, up to 1 wt. % Al₂O₃, or up to 0.7 wt. % Al₂O₃. Preferably, the frit contains 0.3-1 wt. % Al₂O₃. Most preferably, the frit contains 0.3-0.7 wt. % Al₂O₃.

The frit according to the disclosure comprises at least 30 wt. % SiO₂. Higher amounts of silica can provide a more durable glass network, thereby preventing the leaching of other, potentially toxic, elements from the frit. Frits containing amounts of silica below a certain threshold, such as 30 wt. %, can result in the need for hazard classification. In some examples, the frit contains at least 33 wt. % SiO₂, at least 35 wt. % SiO₂ or at least 37 wt. % SiO₂. In some examples, the frit contains up to 50 wt. % SiO₂, up to 45 wt. % SiO₂, or up to 40 wt. % SiO₂. Preferably, the frit contains 35-45 wt. % SiO₂. Most preferably, the frit contains 36-42 wt. % SiO₂.

The frit according to the disclosure comprises 40-60 wt. % Bi₂O₃. In some examples, the frit contains at least 43 wt. % Bi₂O₃, at least 45 wt. % Bi₂O₃ or at least 47 wt. % Bi₂O₃. In some examples, the frit contains up to 55 wt. % Bi₂O₃, up to 52 wt. % Bi₂O₃, or up to 49 wt. % Bi₂O₃. Preferably, the frit contains 42-52 wt. % Bi₂O₃. Most preferably, the frit contains 45-50 wt. % Bi₂O₃.

The frit according to the disclosure comprises more than 3 wt. % TiO₂. In some examples, the frit contains at least 3.5 wt. % TiO₂, at least 4 wt. % TiO₂ or at least 4.5 wt. % TiO₂. In some examples, the frit contains up to 6.5 wt. % TiO₂, up to 5.5 wt. % TiO₂, or up to 5 wt. % TiO₂. Preferably, the frit contains 3.5-7 wt. % TiO₂. Most preferably, the frit contains 4-6 wt. % TiO₂.

The frit according to the disclosure comprises 0.2-4 wt. % K₂O. In some examples, the frit contains at least 0.3 wt. % K₂O, at least 0.5 wt. % K₂O or at least 0.7 wt. % K₂O. In some examples, the frit contains up to 2.5 wt. % K₂O, up to 1.5 wt. % K₂O, or up to 1 wt. % K₂O. Preferably, the frit contains 0.3-2 wt. % K₂O. Most preferably, the frit contains 0.6-1.2 wt. % K₂O.

The frit according to the disclosure comprises 0.1-6 wt. % Li₂O. In some examples, the frit contains at least 0.5 wt. % Li₂O, at least 1 wt. % Li₂O or at least 2 wt. % Li₂O. In some examples, the frit contains up to 5 wt. % Li₂O, up to 4 wt. % Li₂O, or up to 3.5 wt. % Li₂O. Preferably, the frit contains 0.5-5 wt. % Li₂O. Most preferably, the frit contains 2.6-3.6 wt. % Li₂O.

The frit according to the disclosure comprises 0.1-6 wt. % Na₂O. In some examples, the frit contains at least 0.5 wt. % Na₂O, at least 1 wt. % Na₂O or at least 2 wt. % Na₂O. In some examples, the frit contains up to 4 wt. % Na₂O, up to 3 wt. % Na₂O, or up to 2.5 wt. % Na₂O. Preferably, the frit contains 0.5-4 wt. % Na₂O. Most preferably, the frit contains 1.5-2.5 wt. % Na₂O.

The composition of the frit can be determined by standard analytical methods, such as X-ray fluorescence spectroscopy.

In the examples described above, the frit is in particle form, and the particles have a Dv97 particle size distribution value of up to 1.5 microns. The Dv97 value corresponds to the 97th percentile of the particle size distribution by volume, i.e., 97% of the particles (by volume) have a size of at most Dv97 and 3% of the particles (by volume) have a size larger than Dv97. Preferably, the particles have a Dv97 value of up to 1.2 microns. Most preferably, the particles have a Dv97 value of up to 1 micron. The particle size can be determined using laser diffraction, for instance or preferably using a Malvern Mastersizer 3000. The instrument is known to the skilled person and is commonly used to determine particle sizes. The small particle size facilitates the digital printing, for instance by inkjet printing, onto the ceramic substrate.

### Frit Formation

The frits described above may be formed by heating a mixture of components. For instance, the components can be heated in a continuous or batch furnace, with the heat being provided by gas flame or electricity. The mixture may be heated until the components are melted. The components can be left in the furnace to dwell for a predetermined time period, to allow the components to mix homogenously.

The components to be heated to form the frit are: the chemical elements contained in the frit in elemental form, and/or compounds containing the elements. The compounds containing the elements could be metal oxides (e.g. bismuth oxide) or metal salts (e.g. sodium carbonate).

Once heated, the mixture is cooled. The mixture may be cooled by quenching to an amorphous glassy state. The quenching includes rapid cooling, for instance using water-cooled metal rollers, to produce a flake or granulate material. The flake or granulate material may be crushed prior to milling.

The frits are then milled into particle form, for example by jet milling.

### Ink Mixture

The frit can be incorporated into an ink mixture. The ink mixture comprises the frit, a pigment, and a liquid medium. The ink mixture is a digital ink, such as an inkjet ink.

To provide the ink mixture, the frit is mixed with the pigment (i.e. a coloured substance). The pigment may be an inorganic pigment, such as a synthetic copper chromite spinel. The pigment may be a black pigment.

The Dv97 value of the frit particles and pigment particles is reduced to 1.5 microns or lower by milling the particles. For instance, the frit and the pigment may be processed together or separately in a bead mill to reduce the Dv97 value of the frit particles and pigment particles to 1.5 microns or lower. The frit particles and pigment particles can be mixed before or after the processing in the bead mill.

The pigment and frit particles may be mixed with the liquid medium to provide the ink mixture. In some examples, the mixing of the liquid medium with the pigment and frit particles could occur in the bead mill as part of the particle size reduction process. The liquid medium may be an organic liquid, such as glycol ether. The organic liquid may be (2-methoxymethylethoxy) propanol.

In some examples, the ink mixture includes 30-70 wt. % of the liquid medium, 10-30 wt. % of the pigment, and 20-50 wt. % of the frit. Preferably, the ink mixture includes 40-60 wt. % of the liquid medium, 12.5-22.5 wt. % of the pigment, and 25-40 wt. % of the frit. Most preferably, the ink mixture includes 45-55 wt. % of the liquid medium, 15-20 wt. % of the pigment, and 30-35 wt. % of the frit.

### Application

The method of applying the ink mixture to a ceramic substrate, such as glass, firstly includes loading the ink mixture into a digital printer, such as an inkjet printer. The ink mixture is then applied to the glass by digital printing, such as inkjet printing. The ink mixture may be applied to automotive glass such as sidelite glass (i.e. the windows in a vehicle that are not the windshield or backlight) or quarter glass (otherwise known as quarter light glass). The ink mixture may alternatively be applied to tractor cabin glass, bus window glass, or train window glass. The glass may be tempered glass.

Once the ink mixture has been applied to the glass, the liquid medium in the ink mixture is allowed to evaporate. The glass may then be heated to fuse the frit/pigment mixture to the glass.

There is thus described a frit, an ink mixture, and a method of applying the ink mixture to glass with a number of advantages as detailed above and as follows.

A digital printer can apply a thinner layer of material to glass, when compared to conventional screen printing. Therefore when applying the thinner layer of ink mixture to glass using a digital printer, the frit requires improved properties, as a lower amount of the frit is present on the glass. In the example where the ink mixture is applied to automotive glass in a thin layer using digital printing, the ink should provide an improved ability to block light transmission and also improved chemical durability, relative to inks applied in thicker layers using screen printing.

The frit described herein allows for a higher pigment loading when compared to prior frits, thereby reducing light transmission through the mixture. The frit is also highly resistant to chemical degradation. Furthermore, the frit includes fewer toxic components when compared to prior frits.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims. For example, the proportions of the respective components of the frit can be varied to suit a particular application.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasise an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the applicant may seek protection via the claims in respect of any patentable feature or combination of features hereinbefore referred to and/or shown in the drawings whether or not emphasis has been placed thereon.

1. A frit for digital printing onto a ceramic substrate, wherein the frit comprises:
less than 5 wt. % B₂O₃;
0.3-5 wt. % Al₂O₃;
40-60 wt. % Bi₂O₃;
0.2-4 wt. % K₂O;
0.1-6 wt. % Li₂O;
0.1-6 wt. % Na₂O;
at least 30 wt. % SiO₂; and
more than 3 wt. % TiO₂,
wherein the frit is in particle form and the particles have a Dv97 particle size distribution value of up to 1.5 microns, wherein wt. % means % by weight of the total composition.

2. A frit according to claim 1, wherein the frit is substantially zinc-free, preferably the frit contains less than 0.25 wt. % ZnO, more preferably less than 0.1 wt. %, still more preferably no zinc.

3. A frit according to claim 1, wherein the frit is substantially barium-free, preferably the frit contains less than 1 wt. % BaO, more preferably less than 0.1 wt. % BaO, still more preferably no barium.

4. A frit according to claim 1, wherein the frit comprises less than 3 wt. % B₂O₃.

5. A frit according to claim 1, wherein the frit comprises up to 2.5 wt. % B₂O₃.

6. A frit according to claim 1, wherein the frit comprises up to 2 wt. % B₂O₃.

7. A frit according to claim 1, wherein the frit comprises at least 3.5 wt. % TiO₂.

8. A frit according to claim 1, wherein the frit comprises at least 4 wt. % TiO₂.

9. A frit according to claim 1, wherein the frit comprises at least 2 wt. % Li₂O.

10. A frit according to claim 1, wherein the frit comprises at least 3 wt. % Li₂O.

11. A frit according to claim 1, wherein the frit comprises at least 0.5 wt. % K₂O.

12. A frit according to claim 1, wherein the frit comprises up to 2 wt. % K₂O.

13. A frit according to claim 1, wherein the frit comprises up to 2 wt. % Al₂O₃.

14. A frit according to claim 1, wherein the frit comprises up to 1 wt. % Al₂O₃.

15. A frit according to claim 1, wherein the frit comprises at least 35 wt. % SiO₂.

16. A frit according to claim 1, wherein the Dv97 particle size distribution value of the particles is up to 1 micron.

17. A frit according to claim 1, wherein the frit comprises:
1-2.5 wt. % B₂O₃;
0.3-1 wt. % Al₂O₃;
42-52 wt. % Bi₂O₃;
0.3-2 wt. % K₂O;
0.5-5 wt. % Li₂O;
0.5-4 wt. % Na₂O;
35-45 wt. % SiO₂; and
3.5-7 wt. % TiO₂.

18. A frit according to claim 1, wherein the frit comprises:
1.3-1.9 wt. % B₂O₃;
0.3-0.7 wt. % Al₂O₃;
45-50 wt. % Bi₂O₃;
0.6-1.2 wt. % K₂O;
2.6-3.8 wt. % Li₂O;
1.5-2.5 wt. % Na₂O;
36-42 wt. % SiO₂; and
4-6 wt. % TiO₂.

19. An ink mixture comprising:
the frit of claim 1,
a liquid medium, and
a pigment.

20. A method of applying the ink mixture of claim 19 to glass, wherein the method comprises digitally printing the ink mixture onto the glass.
